(19) United States
(12) Patent Application Publication
(10) Pub. No.: US 2004/0224553 A1
(43) Pub. Date: Nov. 11, 2004

(54) Extraction tool for extracting electrical connector

(76) Inventors: Zhen-Da Hung, Tu-Chen (TW); Chia Ming Kuo, Tu-Chen (TW); Lung-Sheng Tai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/629,171

(22) Filed: Jul. 28, 2003

(30) Foreign Application Priority Data
May 9, 2003 (TW) 92208540

(51) Int. Cl. H01R 13/00

(52) U.S. Cl. 439/483

(57) ABSTRACT

An extraction tool (1) is adapted to extract an electrical connector (4) from a mating electrical device. The extraction tool includes a pull tab (2) and a retention element (3). The retention element extends from the pull tab and includes a fixing portion (32) on an end thereof retained on the pull tab, thereby cooperating with the pull tab to form a closed loop. With the closed loop surrounding the electrical connector, the extraction tool for electrical connector is capable of being securely and easily mounted on the electrical connector.

### CROSS-REFERENCE TO RELATED APPLICATIONS

This application is related to a co-pending U.S. patent application entitled “EXTRACTION DEVICE FOR ELECTRICAL CONNECTOR”, with application Ser. No. 10/321,273, filed on Dec. 16, 2002, invented by Chung et al., a co-pending U.S. patent application entitled “ELECTRICAL CONNECTOR ASSEMBLY WITH EXTRACTION TOOL”, with application Ser. No. 10/302,518, filed on Nov. 22, 2002, invented by Chung et al., and a co-pending U.S. patent application entitled “PULL TAB FOR EXTRACTING ELECTRICAL CONNECTOR”, with application Ser. No. 10/120,633, filed on Apr. 10, 2002, invented by Ko, an application with an known serial number titled “PULL TAB FOR EXTRACTING ELECTRICAL CONNECTOR” and another application with an unknown serial number titled “EXTRACTION TAB FOR EXTRACTING ELECTRICAL CONNECTOR”, and all assigned to the same assignee of the present invention.

### BACKGROUND OF THE INVENTION

1. Field of the Invention

The present invention relates to an extraction tool, and more particularly, to an extraction tool for disengaging an electrical connector from an electrical device which mates with the electrical connector.

2. Description of Prior Art

To comply with the current trend of light weight and compactness, many electrical devices tend to employ small connectors such as cable connectors for transmitting signals. These connectors need to mate tightly with corresponding devices for transmitting signals reliably, which usually requires a great amount of applied force to extract these connectors from these devices when there is necessary to replace these connectors with other connectors for different applications. Their separation is normally accomplished by manually shaking the connectors (or perhaps with prying tools) when the connectors are pulled away from the devices. However, the shaking action to the connectors inevitably bends the contacts of the small connectors and damages the connectors and/or the devices. It is also difficult to manually pull a connector having a very small size.

In order to solve the above-mentioned problems, Japanese Publication for Laid-Open Patent Application No. 11-208461 discloses an extraction tab for extracting an L-type connector. The extraction tab comprises a front engaging aperture, a middle fixing hole and a rear manual portion. The engaging aperture is provided for engaging with a lower portion of a vertical mating portion of the connector. The fixing hole engages with a horizontal cable which connects with the connector. In use, by pulling the manual portion of the extraction tab upwardly, the L-type connector can be easily extracted from a mating electrical device. However, if the engaging aperture doesn't engage securely with the mating portion of the connector, the extraction tab tends to break away from the mating portion. In order to ensure securely engaging with the mating portion of the connector, a profile of the engaging aperture tend to be configured a little smaller than an outer profile of the mating portion. It is difficult to assemble such a small engaging aperture on the connector having a small size.

Hence, an improved extraction tool is desired to overcome the above-mentioned shortcomings.

### BRIEF SUMMARY OF THE INVENTION

The main object of the present invention is to provide an extraction tool which is capable of being securely and easily mounted on an electrical connector.

An extraction tool is provided for extracting an electrical connector from a mating electrical device. The extraction tool includes a pull tab and a retention element. The retention element extends from the pull tab and includes a fixing portion an end thereof retained on the pull tab, thereby cooperating with the pull tab to form a closed loop. With the closed loop enclosing the mating portion of the electrical connector, the extraction tool is reliably and easily mounted on the electrical connector and is effectively prevented from breaking away from the electrical connector.

In use, by pulling the pull tab upwardly, the electrical connector can be easily extracted from the mating electrical device.

Other objects, advantages and novel features of the invention will become more apparent from the following detailed description when taken in conjunction with the accompanying drawings.

### BRIEF DESCRIPTION OF THE DRAWINGS

FIG. 1 is a top view of an extraction tool according to the present invention.

FIG. 2 is a partially assembled view of the extraction tool shown in FIG. 1 and an electrical connector.

FIG. 3 is an assembled view of FIG. 2.

FIG. 4 is another assembled view of FIG. 2.

### DETAILED DESCRIPTION OF THE INVENTION

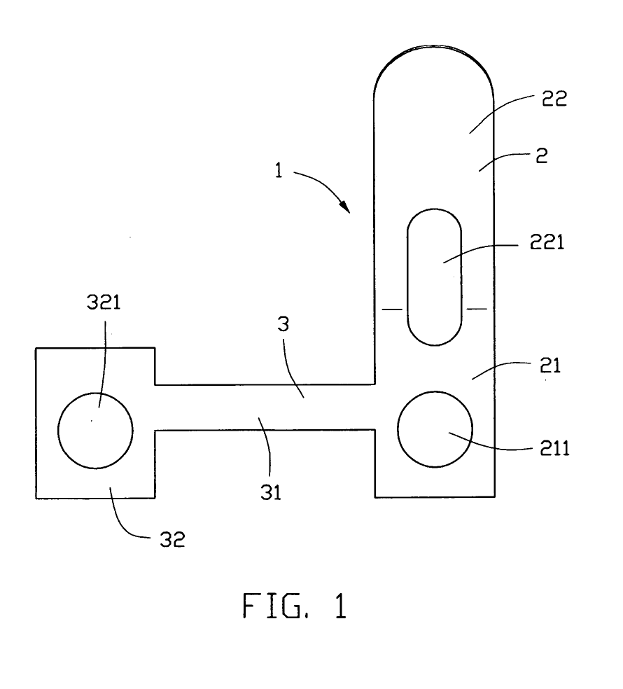

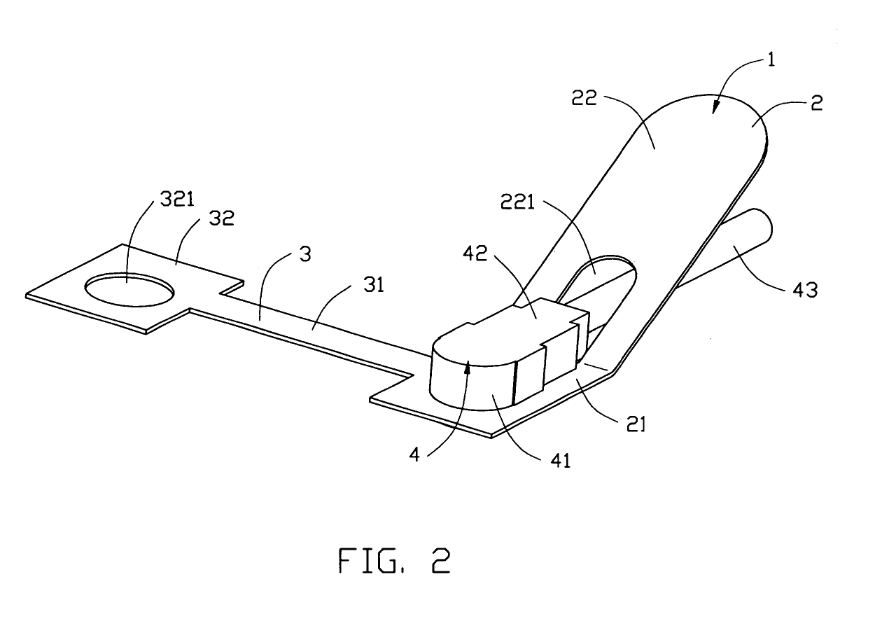

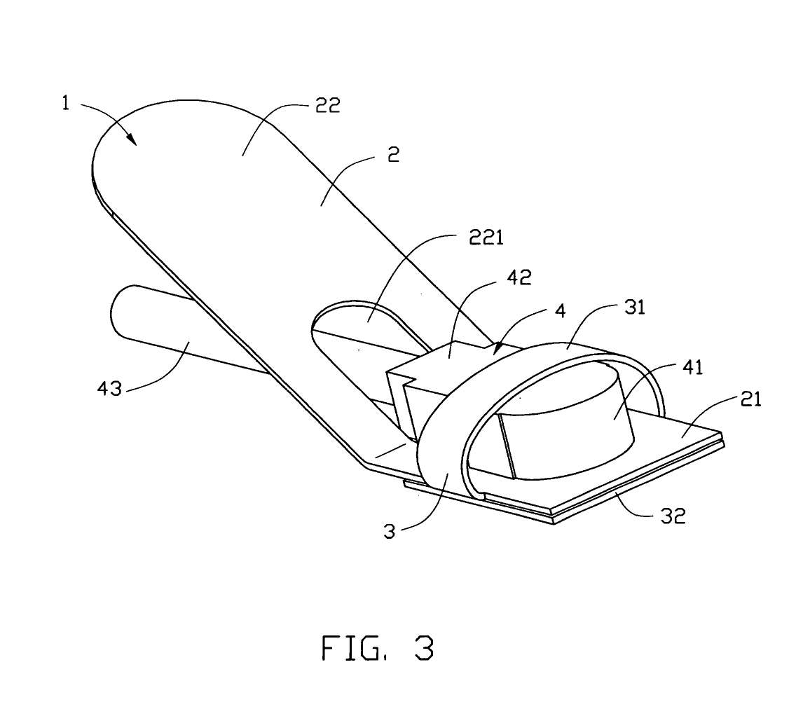

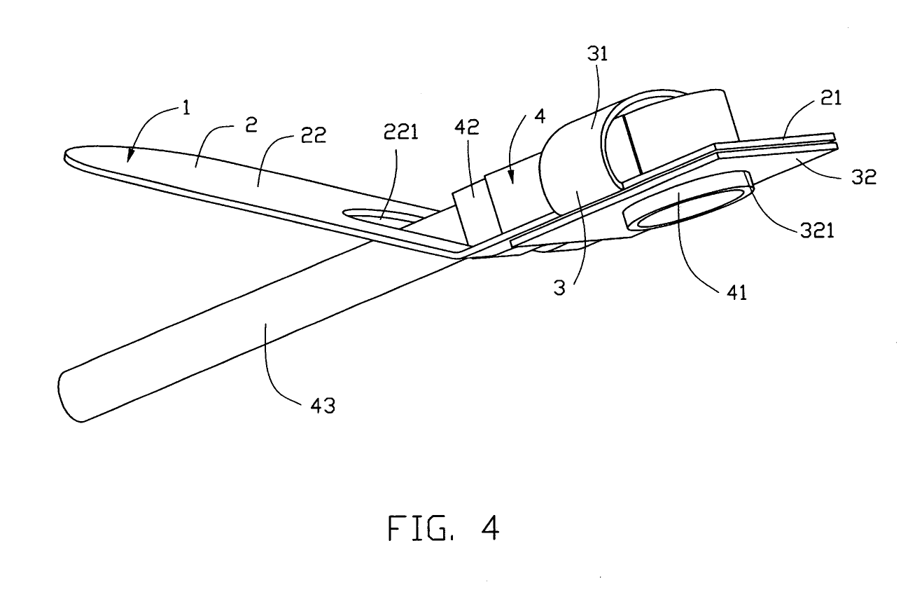

As shown in FIGS. 1-4, an extraction tool 1 according to a preferred embodiment of the present invention is mounted on an electrical connector 4 for extracting the electrical connector 4 from an electrical device (not shown) which mates with the electrical connector 4.

The extraction tool 1 is made of resilient insulative material. The extraction tool 1 comprises a pull tab 2 and a retention element 3 extending from the pull tab 2. The pull tab 2 has an elongate and strip-like configuration and comprises an engaging portion 21 and a handling portion 22. The engaging portion 21 horizontally extends and defines a circular engaging opening 211 in a substantially central portion thereof. The handling portion 22 extends rearwardly and upwardly from the engaging portion 21. The handling portion 22 defines an elliptic aperture 221 therethrough. The aperture 221 comprises a front portion partially defined through the engaging portion 21. The retention element 3 comprises a connection portion 31 and a fixing portion 32. The connection portion 31 perpendicularly extends from a side edge of the engaging portion 21. The fixing portion 32 extends from the connection portion 31. The fixing portion 32 defines a circular fixing aperture 321. A profile of the fixing aperture 321 is configured corresponding to that of engaging opening 211 of the engaging portion 21.

In this preferred embodiment, the electrical connector 4 is a cable end connector. The cable end connector 4 comprises an upright cylindrical mating portion 41, a horizontally extending cable 43 and a cable-retaining portion 43 for retaining a cable 4. An outer profile of the mating portion 41 is configured substantially corresponding to a profile of the engaging opening 211 of the pull tab 2.

In assembly, the engaging opening 211 of the engaging portion 21 engages with a lower portion of the mating portion 41. The elliptic aperture 221 of the handling portion 22 encloses the cable-retaining portion 42 and the cable 43. The connection portion 31 of the retention element 3 is curved into an arc to cover an upper section of the mating portion 41. The fixing portion 32 is curved to overlap on a lower surface of the engaging portion 21 and the fixing aperture 321 engages with the lower section of the mating portion 41 of the electrical connector 4. The fixing portion 32 is adhered to the lower surface of the engaging portion 21. The retention element 3 and the engaging portion 21 of the pull tab 2, therefore, construct a closed loop. With the closed loop enclosing the mating portion 41 of the electrical connector 4, the extraction tool 1 is reliably retained on the electrical connector 4 and is effectively prevented from breaking away from the electrical connector 4.

In use, holding and upwardly pulling the handling portion 22 of the pull tab 1, the engaging portion 21 exerts an upper extracting force on the mating portion 41, thereby upwardly pulling the electrical connector 4 out of the electrical device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An extraction tool, assembled to an electrical connector for disengaging the electrical connector from a mating electrical device, comprising:
a pull tab; and
a retention element comprising a connection portion extending from the pull tab and a fixing portion fixed on the pull tab to form a closed loop for enclosing the electrical connector therein.

2. The extraction tool as claimed in claim 1, wherein the pull tab comprises an engaging portion, the connection portion extending from the engaging portion.

3. The extraction tool as claimed in claim 2, wherein the engaging portion and the fixing portion overlap each other and each defines a hole for engaging with the electrical connector.

4. The extraction tool as claimed in claim 3, wherein the pull tab comprises a handling portion extending from the engaging portion.

5. A cable connector assembly comprising:
a cable connector comprising an upright mating portion and a cable-retaining portion perpendicularly extending from the mating portion; and
an extraction tool for extracting the cable connector from an electrical device which mates with the cable connector, the extraction tool comprising a pull tab and a retention element, the pull tab engaging with a section of the mating portion of the cable connector, the retention element comprising a connection portion extending from the pull tab and a fixing portion fixed on the pull tab to form an upright loop enclosing the mating portion of the cable connector therein.

6. The cable connector assembly as claimed in claim 5, wherein the pull tab comprises an engaging portion engaging with the mating portion of the cable connector, the connection portion extending from the engaging portion.

7. The cable connector assembly as claimed in claim 6, wherein the engaging portion and the fixing portion overlap each other and each defines a hole for engaging with the mating portion of the electrical connector.

8. The cable connector assembly as claimed in claim 7, wherein the pull tab comprises a handling portion extending from the engaging portion.

9. An electrical connector assembly comprising:
a cable connector including a vertical mating section with a horizontal cable retaining portion extending from said mating section;
an extracting tool including stacked first and second plates located below the cable retaining portion, wherein through both of said first and second plates said mating section extends downwardly, a connection portion linked between said first plate and said second plate to form a loop configuration surrounding said cable retaining portion; and
a pull tab extending from one of said first and second plates and said connection portion.

10. The assembly as claimed in claim 9, wherein said pull tab extends from the first plate which is located upon the second plate.

11. The assembly as claimed in claim 9, wherein said pull tab defines an aperture through which a cable of said cable connector extends.
